(19) United States
(12) Patent Application Publication
(10) Pub. No.: US 2016/0357138 A1
(43) Pub. Date: Dec. 8, 2016

(54) SHEET FEEDING APPARATUS, IMAGE FORMING APPARATUS AND IMAGE FORMATION SYSTEM

(71) Applicant: Konica Minolta, Inc., Tokyo (JP)

(72) Inventor: Hajime NAKAMURA, Tokyo (JP)

(21) Appl. No.: 15/174,043

(22) Filed: Jun. 6, 2016

(30) Foreign Application Priority Data
Jun. 8, 2015 (JP) 2015-115566

(51) Int. Cl. G03G 15/00; B65H 3/48; B65H 7/04; B65H 3/12

(52) U.S. Cl. CPC G03G 15/6529; B65H 3/128; B65H 3/48; B65H 7/04; B65H 2406/323; B65H 2553/414; B65H 2553/612

(57) ABSTRACT

A sheet feeding apparatus includes: a conveyance belt conveying the sheets being placed on the sheet placement tray and adhering in a sheet conveyance direction; a suction section provided at an inner side of the conveyance belt and suctioning air to cause the sheets placed on the sheet placement tray to adhere thereto; a displacement member at a position opposite to the suction section with the sheets in between when the sheets exist on the sheet placement tray or opposite to the suction section when no sheet exists on the tray, and being displaced in position in accordance with a suction force received from the suction section; a displacement detection section detecting displacement of the position of the displacement member; and a control section detecting the presence or absence of a sheet in the sheet storage section based on the detection result of the displacement detection section.

### CROSS REFERENCE TO RELATED APPLICATIONS

This application is entitled to and claims the benefit of Japanese Patent Application No. 2015-115566, filed on Jun. 8, 2015, the disclosure of which including the specification, drawings and abstract is incorporated herein by reference in its entirety.

### BACKGROUND OF THE INVENTION

1. Field of the Invention

The present invention relates to a sheet feeding apparatus, an image forming apparatus and an image formation system.

2. Description of Related Art

Conventionally, air-assisted sheet feeding apparatuses are known as sheet feeding apparatuses that supply sheets to an image forming apparatus such as a copier or printer (e.g., Japanese Patent Application Laid-Open No. 2003-149995). As described in Japanese Patent Application Laid-Open No. 2003-149995, the air-assisted sheet feeding apparatus (hereinafter referred to as “air sheet feeding apparatus”) is provided with a sheet storage section, a suction conveyance section, a floating-air blowing section, a separating-air blowing section and an exit roller section or the like.

The suction conveyance section is provided with an endless conveyance belt including many suction holes and an air suction section installed at an inner side of the conveyance belt. The suction conveyance section is disposed above the sheet storage section to suction and convey sheets one by one from a pile of sheets placed on a sheet placement tray of the sheet storage section. The floating-air blowing section blows air over one side of the pile of sheets from a direction orthogonal to the sheet conveyance direction (both sides of the sheet width direction) and causes a few uppermost sheets of the pile of sheets to float. The separating-air blowing section blows air toward the plurality of sheets adhering to the conveyance belt from a downstream side in the sheet conveyance direction and separates only the one uppermost sheet. The exit roller section is disposed downstream of the suction conveyance section in the sheet conveyance direction and outputs the sheets conveyed by the suction conveyance section further to the downstream side.

The air sheet feeding apparatus causes sheets to float by air blown by the floating-air blowing section and causes the floating sheets to adhere to the conveyance belt by the air suction section. The conveyance belt runs in this condition and the sheets are thereby conveyed. In order to prevent two or more sheets from being conveyed while adhering to the conveyance belt, so-called multi-feeding, the separating-air blowing section blows separating air between a first sheet (uppermost sheet of the pile of sheets) which directly adheres to the conveyance belt and a second sheet (next uppermost sheet of the pile of sheets) which adheres to the conveyance belt via the first sheet.

When the first sheet conveyed by the suction conveyance section reaches the exit roller section, the conveyance belt stops running and the exit roller section conveys the sheet. In the suction conveyance section, the first sheet slides along a conveyance surface of the conveyance belt. When the first sheet is conveyed by a predetermined length by the exit roller section, then blowing of floating air starts to feed the next sheet (second sheet). When a rear-end position of the first sheet enters the suction conveyance section, the second sheet gradually appears on the surface and directly adheres to the conveyance belt.

Among air sheet feeding apparatuses, there is one provided with an auto tray switch function that, when the sheet storage section runs out of sheets during image formation processing of the image forming apparatus, switches the sheet storage section to another one with the same setting (paper size, paper type and/or the like) and continues sheet feeding. The air sheet feeding apparatus having this auto tray switch function is provided with a sheet existence detection section that detects the presence or absence of a sheet in the sheet storage section (e.g., Japanese Patent Application Laid-Open No. 2004-331358, Japanese Patent Application Laid-Open No. 61-238633 and Japanese Patent Application Laid-Open No. 2004-269233) and when the sheet existence detection section detects that there is no sheet in the sheet storage section, the auto tray switch function is executed.

Japanese Patent Application Laid-Open No. 2004-331358 discloses a technique of detecting the presence or absence of a sheet in the sheet storage section using a reflection-type photointerrupter (hereinafter referred to as “reflection-type sensor”) that contactlessly detects various objects which are detection target objects.

Japanese Patent Application Laid-Open No. 61-238633 discloses a technique of detecting the presence or absence of a sheet in the sheet storage section by slidably supporting the actuator so that a vertex of an arrow-type lever (hereinafter referred to as “actuator”) comes into contact with a sheet in the sheet storage section (cassette) and detecting a sliding position of the actuator accompanying a change in the amount of sheet in the sheet storage section.

Japanese Patent Application Laid-Open No. 2004-269233 discloses a transmission type sensor that includes a light-emitting section and a light-receiving section provided at positions sandwiching a pile of recording paper loaded on a base plate of the sheet storage section (sheet feed tray) in a thickness direction, causes the light to transmit in the thickness direction, detects the amount of transmitted light and thereby detects the presence or absence of a sheet in the sheet storage section.

However, in the above-described air sheet feeding apparatus, after a plurality of sheets are made to float by air blowing by the floating-air blowing section, sheets below the first sheet directly adhering to the conveyance belt (that is, the second and subsequent sheets) may float by blowing of separating air over the plurality of sheets. In this case, the techniques described in above Japanese Patent Application Laid-Open No. 2004-331358, Japanese Patent Application Laid-Open No. 61-238633 and Japanese Patent Application Laid-Open No. 2004-269233 have a problem that the presence or absence of a sheet in the sheet storage section may not be accurately detected immediately after the first sheet adheres to the conveyance belt and conveyed.

That is, when the reflection-type sensor described in Japanese Patent Application Laid-Open No. 2004-331358 is used, the posture of the floating sheet may not be fixed, such as an undulated posture, light emitted from the reflection-type sensor impinges on a sheet and is spread, that is, the spread light does not reach the light-receiving section of the reflection-type sensor, resulting in an erroneous detection that there is no sheet despite the fact that there is a sheet in the sheet storage section.

On the other hand, when the actuator described in Japanese Patent Application Laid-Open No. 61-238633 is used, since the sheet is floating, there may be positions where the actuator cannot contact the sheet, thus erroneously detecting that there is no sheet despite the fact that there is a sheet in the sheet storage section.

When the transmission-type sensor described in Japanese Patent Application Laid-Open No. 2004-269233 is used, in order to accurately detect the presence or absence of a sheet in the sheet storage section, it is necessary to make a detection and/or adjustment on the type of the sheet (e.g., transparent sheet (OHP)) or the presence or absence of dirt in the light-receiving section and the light-emitting section of the transmission-type sensor every time the detection condition is changed. Therefore, if no detection and/or adjustment are/is made despite the fact that the detection condition has been changed, there may be a case where it is not possible to accurately detect the presence or absence of a sheet in the sheet storage section.

As described above, when it is not possible to accurately detect the presence or absence of a sheet in the sheet storage section, the system may wait until the sheet floating due to blowing of separating air descends onto the sheet placement tray, that is, the floating of the sheet comes to an end or the system may wait for a certain period of time and determine, when there is no change in the detection result of the sheet existence detection section, that there is no sheet or may combine a plurality of sheet existence detection sections to detect that there is no sheet. As a result, the timing of detecting the presence or absence of a sheet in the sheet storage section, and consequently, the timing of executing the auto tray switch function may be late, leading to a decrease in productivity.

### SUMMARY OF THE INVENTION

An object of the present invention is to provide a sheet feeding apparatus, an image forming apparatus and an image formation system that can accurately detect the presence or absence of a sheet in a sheet storage section without causing a decrease in productivity.

To achieve at least one of the abovementioned objects, a sheet feeding apparatus reflecting one aspect of the present invention includes: a sheet storage section including a sheet placement tray where a plurality of sheets are to be placed, the sheet storage section being configured to store the sheets; a conveyance belt located above the sheets placed on the sheet placement tray, the conveyance belt being configured to convey the sheets adhering in a sheet conveyance direction; a suction section provided at an inner side of the conveyance belt and configured to suction air to cause the sheets placed on the sheet placement tray to adhere to the conveyance belt; a displacement member provided at a position opposite to the suction section with the sheets placed in between when the sheets exist on the sheet placement tray or at a position opposite to the suction section when no sheet exists on the sheet placement tray, the displacement member being displaced in position in accordance with a suction force received from the suction section; a displacement detection section configured to detect displacement of the position of the displacement member; and a control section configured to detect the presence or absence of a sheet in the sheet storage section based on the detection result of the displacement detection section.

Desirably, in the sheet feeding apparatus, the position of the displacement member is displaced in a suction direction by the suction section in accordance with the suction force received from the suction section.

Desirably, the sheet feeding apparatus further includes a restriction member configured to restrict displacement of the position of the displacement member.

Desirably, in the sheet feeding apparatus, the displacement member is configured to be rotatable in a predetermined rotating direction and a rotation position in the rotating direction is displaced in accordance with the suction force received from the suction section.

Desirably, in the sheet feeding apparatus, the displacement member is provided on a rear-end side in the sheet conveyance direction of the sheets placed on the sheet placement tray.

Desirably, in the sheet feeding apparatus, the suction section performs a suction operation so that a suction force at a first position opposite to the displacement member is stronger than a suction force at a second position other than the first position in the sheet conveyance direction.

Desirably, in the sheet feeding apparatus, the displacement member is provided at the sheet placement tray, and when no sheet exists on the sheet placement tray, a position of the sheet placement tray is controlled so that the position of the displacement member is displaced by the suction force received from the suction section.

An image forming apparatus reflecting another aspect of the present invention includes: a sheet storage section including a sheet placement tray where a plurality of sheets are to be placed, the sheet storage section being configured to store the sheets; a conveyance belt located above the sheets placed on the sheet placement tray, the conveyance belt being configured to convey the sheets adhering in a sheet conveyance direction; a suction section provided at an inner side of the conveyance belt and configured to suction air to cause the sheets placed on the sheet placement tray to adhere to the conveyance belt; a displacement member provided at a position opposite to the suction section with the sheets placed in between when the sheets exist on the sheet placement tray or at a position opposite to the suction section when no sheet exists on the sheet placement tray, the displacement member being displaced in position in accordance with a suction force received from the suction section; a displacement detection section configured to detect displacement of the position of the displacement member; and a control section configured to detect the presence or absence of a sheet in the sheet storage section based on the detection result of the displacement detection section.

An image formation system reflecting still another aspect of the present invention includes: the sheet feeding apparatus according to claim 1; and an image forming apparatus connected to the sheet feeding apparatus and configured to form an image on a sheet fed from the sheet feeding apparatus.

### BRIEF DESCRIPTION OF DRAWINGS

The present invention will become more fully understood from the detailed description given hereinbelow and the appended drawings which are given by way of illustration only, and thus are not intended as a definition of the limits of the present invention, and wherein:

FIG. 1 is a diagram illustrating an overall configuration of an image formation system according to the present embodiment;

FIG. 2 is a diagram illustrating main parts of a control system of a sheet feeding apparatus in the present embodiment;

FIG. 3 is a perspective view illustrating a sheet feeding unit which is a main part of the sheet feeding apparatus of the present embodiment;

FIG. 4 is a cross-sectional view along line indicated by arrows in FIG. 3;

FIGS. 5A and 5B are diagrams illustrating a configuration of detecting the presence or absence of a sheet in the sheet storage section;

FIG. 6 is a flowchart illustrating an example of sheet feeding operation of the sheet feeding apparatus; and

FIGS. 7A and 7B are diagrams illustrating a modification of the configuration of detecting the presence or absence of a sheet in the sheet storage section.

### DESCRIPTION OF THE PREFERRED EMBODIMENTS

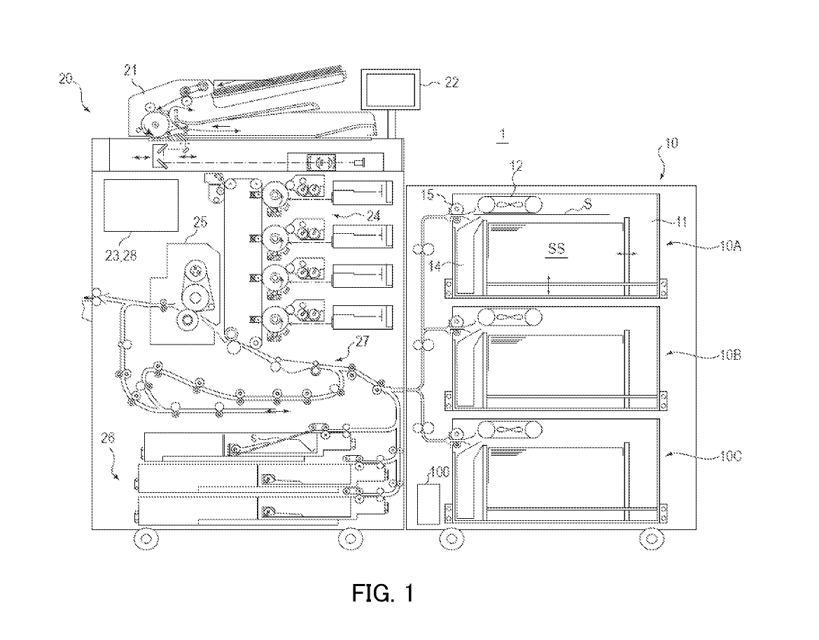

Hereinafter, an embodiment of the present invention will be described in detail with reference to the accompanying drawings. FIG. 1 is a diagram illustrating an overall configuration of image formation system 1 of the present embodiment. As shown in FIG. 1, image formation system 1 has a configuration in which external large-volume sheet feeding apparatus 10 (hereinafter referred to as “sheet feeding apparatus 10”) is connected to a side (right side in FIG. 1) of image forming apparatus 20.

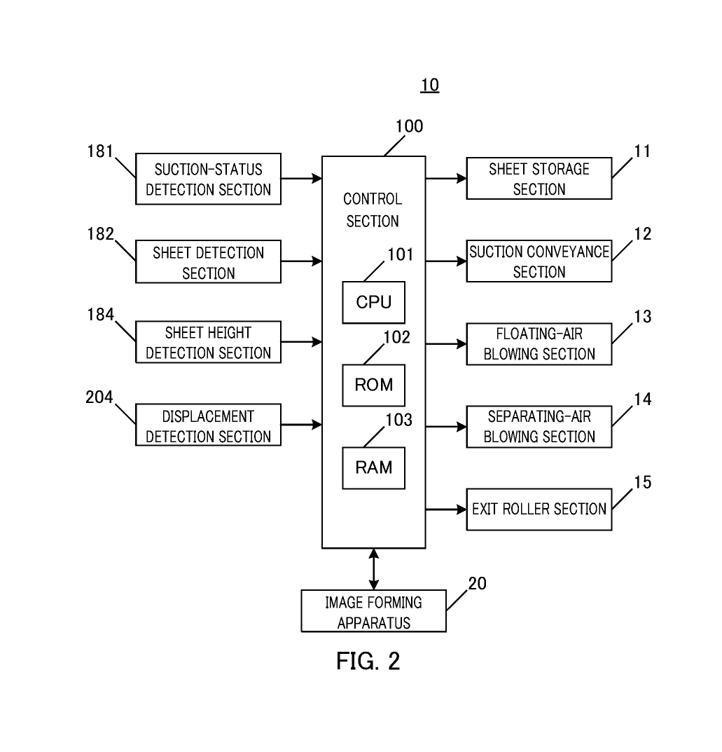

Sheet feeding apparatus 10 includes therein three sheet feeding units 10A to 10C and outputs sheets to image forming apparatus 20 one by one. As shown in FIG. 2, sheet feeding apparatus 10 includes control section 100 including central processing unit (CPU) 101, read only memory (ROM) 102, random access memory (RAM) 103 or the like. Control section 100 performs centralized controls on operation of each block of sheet feeding apparatus 10 in cooperation with control section 28 of image forming apparatus 20. More specifically, control section 100 controls operations of sheet storage section 11, suction conveyance section 12, floating-air blowing section 13, separating-air blowing section 14 and exit roller section 15 based on a control signal from image forming apparatus 20 or input signals from suction-status detection section 181, sheet detection section 182 and sheet height detection section 184, which will be described later. Details of sheet feeding units 10A to 10C will be described later.

Image forming apparatus 20 is an intermediate transfer type color image forming apparatus using an electrophotograph process technique. Image forming apparatus 20 adopts a longitudinal tandem scheme whereby photoconductor drums corresponding to four CMYK colors are arranged in series in an intermediate transfer belt running direction (vertical direction) and respective color toner images are sequentially transferred to the intermediate transfer belt by a single procedure. That is, image forming apparatus 20 transfers (primary transfer) the respective color toner images of Y (yellow), M (magenta), C (cyan) and K (black) formed on the photoconductor drums to the intermediate transfer belt, superimposes the four color toner images on the intermediate transfer belt, and then transfers (secondary transfer) the color toner images to the sheet and thereby forms an image.

Image forming apparatus 20 includes image reading section 21, operation display section 22, image processing section 23, image forming section 24, fixing section 25, sheet feeding section 26, sheet conveyance section 27 and control section 28.

Control section 28 includes a central processing unit (CPU), a read only memory (ROM) and a random access memory (RAM) or the like. The CPU reads a program corresponding to processing contents from the ROM, develops the program in the RAM and performs centralized control on operation of each block of image forming apparatus 20 in cooperation with the deployed program. Control section 28 controls operation of sheet feeding apparatus 10 in cooperation with control section 100 of sheet feeding apparatus 10.

Image reading section 21 is provided with an automatic document sheet feeding apparatus (ADF: auto document feeder) and a document image scanning apparatus (scanner) or the like. In image reading section 21, a document conveyed onto contact glass from the auto document feeder or a document placed on the contact glass is read by the scanner and input image data is thereby generated.

Operation display section 22 is composed of a liquid crystal display (LCD) with a touch panel and functions as a display section and an operation section.

Image processing section 23 performs various kinds of correction processing such as tone correction, color correction, shading correction in accordance with an initial setting or user setting and digital image processing such as compression processing on the input image data. Image forming section 24 is controlled based on the image data subjected to such processing.

Image forming section 24 forms an image using respective color toners of a Y component, an M component, a C component and a K component based on the image data. Image forming section 24 is provided with a photoconductor drum, a charging apparatus, an exposing device, a developing device and an intermediate transfer apparatus. In image forming section 24, the surface of the photoconductor drum is uniformly charged by the charging apparatus. The exposing device irradiates the charged photoconductor drum with laser light based on the image data, and thereby forms an electrostatic latent image on the surface of the photoconductor drum. The developing device supplies toner to the photoconductor drum on which the electrostatic latent image is formed, thereby makes the electrostatic latent image visible and forms a toner image. The intermediate transfer apparatus having an intermediate transfer belt or the like transfers the toner image to a sheet.

Fixing section 25 includes an upper fixing section having a fixing surface side member disposed on a fixing surface (the surface on which the toner image is formed) side of the sheet, a lower fixing section having a rear side supporting member disposed on a rear surface (the surface opposite to the fixing surface) side of the sheet and a heating source or the like. The rear side supporting member is brought into pressure contact with the fixing surface side member and a fixing nip is thereby formed for conveying the sheet tightly sandwiched therebetween. Fixing section 25 applies heat and pressure to the sheet conveyed with a secondary-transferred toner image using the fixing nip, and thereby fixes the toner image on the sheet.

Sheet feeding section 26 includes a plurality of (three in FIG. 1) sheet feed trays. Each sheet feed tray stores sheets identified based on a basis weight and size or the like (standard sheet, special sheet) for each predetermined type.

Sheet conveyance section 27 conveys the sheet fed from sheet feeding section 26 or sheet feeding apparatus 10 to image forming section 24. When the sheet passes through the secondary transfer section of image forming section 24, a toner image on the intermediate transfer belt is collectively secondary-transferred to one surface of the sheet and subjected to fixing processing at fixing section 25. The sheet on which an image is formed is ejected to outside of the apparatus by a sheet ejection roller. When an image is formed on both sides of the sheet, the sheet with an image formed on the surface thereof is conveyed to a rear surface conveyance path and conveyed to image forming section 24 as an inverted image.

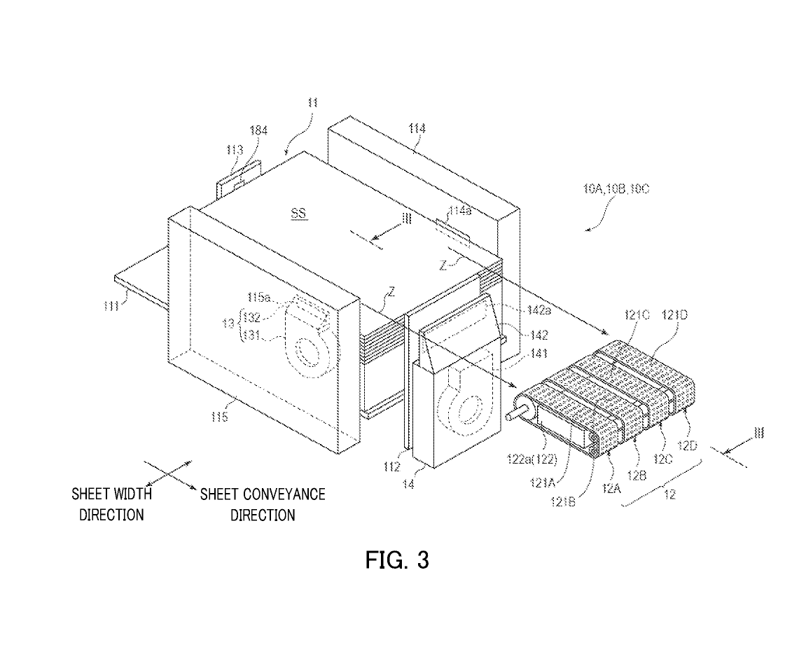

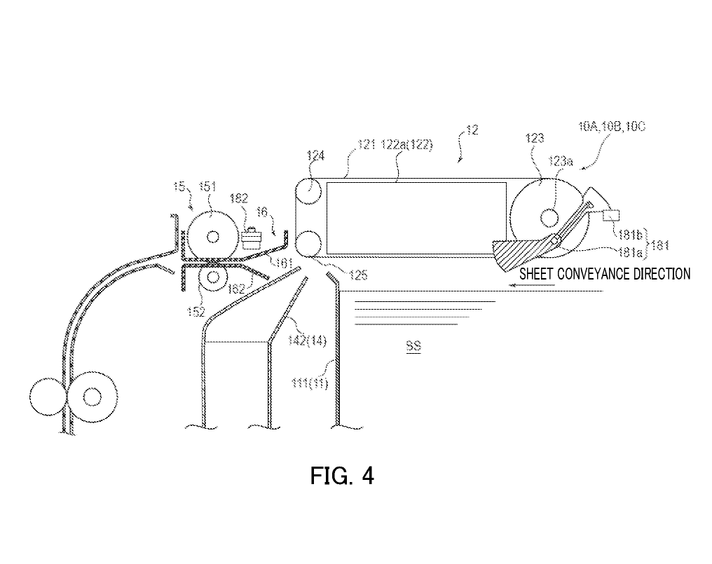

FIG. 3 is a perspective view illustrating each of sheet feeding units 10A to 10C which are main parts of sheet feeding apparatus 10. FIG. 3 shows suction conveyance section 12 shifted toward the downstream side in the sheet conveyance direction by a length indicated by arrow Z. FIG. 4 is a cross-sectional view along line indicated by arrows in FIG. 3. Hereinafter, the “downstream side in the sheet conveyance direction” may be called a “front-end side” and the “upstream side in the sheet conveyance direction” may be called “rear-end side.”

As shown in FIGS. 3 and 4, each of sheet feeding units 10A to 10C includes sheet storage section 11, suction conveyance section 12, floating-air blowing section 13, separating-air blowing section 14, exit roller section 15 and guide section 16 or the like.

Sheet storage section 11 includes sheet placement tray 111, front-end restriction member 112, rear-end restriction member 113 and side-end restriction members 114 and 115, and stores a plurality of sheets. For example, sheet storage section 11 of sheet feeding unit 10A stores 1300 sheets, sheet storage section 11 of each sheet feeding unit 10B,10C stores 1850 sheets, a total of on the order of 5000 sheets. Sheet storage section 11 can be drawn from sheet feeding apparatus 10 via guide rails.

Sheet placement tray 111 is enabled to ascend or descend so that a top end surface (uppermost sheet) of a pile of sheets SS placed thereon is always kept at a fixed position. Sheet placement tray 111 descends to a lowest position when supplying sheets. The lifting operation of sheet placement tray 111 is controlled by control section 100. Front-end restriction member 112 is fixed to a front end of sheet placement tray 111 and restricts the front end position of the pile of sheets SS.

Rear-end restriction member 113 is configured to be movable in the sheet conveyance direction and is disposed in accordance with a sheet length of the pile of sheets SS. Rear-end restriction member 113 lightly presses the pile of sheets SS from the rear-end side and restricts the rear-end position of the pile of sheets SS. Rear-end restriction member 113 maintains a height and a shape that allow rear-end restriction member 113 to always restrict the rear-end position of a sheet also when the sheets float due to the air blown by floating-air blowing section 13 or separating-air blowing section 14. Rear-end restriction member 113 is provided with sheet height detection section 184 that detects the height of the uppermost position of the pile of sheets SS loaded on sheet placement tray 111. Control section 100 controls the lifting operation of sheet placement tray 111 based on the detection result of sheet height detection section 184.

Side-end restriction members 114 and 115 are configured to be movable in a sheet width direction and disposed in accordance with the sheet width of the pile of sheets SS. Side-end restriction members 114 and 115 lightly press the pile of sheets SS from both sides in the sheet width direction to restrict the side-end positions of the pile of sheets SS. Side-end restriction members 114 and 115 have a hollow structure and incorporate floating-air blowing section 13. Side-end restriction members 114 and 115 include air blowing ports 114a and 115a for the air blown from floating-air blowing section 13 at upper parts of the inner surface (surface contacting the pile of sheets SS). Air blowing ports 114a and 115a are disposed so that at least part thereof overlaps suction conveyance section 12 in the sheet conveyance direction.

Suction conveyance section 12 includes first suction conveyance section 12A, second suction conveyance section 12B, third suction conveyance section 12C and fourth suction conveyance section 12D arranged in parallel in the sheet width direction and is disposed above sheet placement tray 111. Since first suction conveyance section 12A to fourth suction conveyance section 12D have the same configuration, common components are assigned the same reference numerals, and when the respective components are distinguished from each other, A, B, C and D are added to their respective reference numerals, for convenience of illustration and description.

Suction conveyance section 12 includes endless conveyance belt 121 and air suction section 122 (corresponds to the “suction section” in the present invention) disposed at an inner side of conveyance belt 121. Conveyance belt 121 has many suction holes over the entire surface. Conveyance belt 121 is wound around large-diameter roller 123 provided on the upstream side in the sheet conveyance direction of air suction section 122 and around two small-diameter rollers 124 and 125 provided on the front side (referred to as “upper small-diameter roller 124” and “lower small-diameter roller 125” when these are distinguished from each other). Large-diameter roller 123 and small-diameter rollers 124 and 125 are drum-shaped (crown-shaped) to prevent lateral dislocation of conveyance belt 121 to be wound.

Large-diameter rollers 123A to 123D are attached to common roller shaft 123a in correspondence with respective conveyance belts 121A to 121D. Roller shaft 123a is connected to a drive motor via a power transmission system (not shown). Large-diameter roller 123 rotates as control section 100 drives the drive motor, and conveyance belt 121 runs in a certain direction.

Upper small-diameter rollers 124A to 124D are attached to a common roller shaft in correspondence with respective conveyance belts 121A to 121D. The uppermost position of large-diameter roller 123 is the same as the uppermost position of upper small-diameter roller 124. Upper small-diameter roller 124 rotates following the running of conveyance belt 121.

Lower small-diameter rollers 125A to 125D are attached to a common roller shaft in correspondence with respective conveyance belts 121A to 121D. The lowest position of large-diameter roller 123 is the same as the lowest position of lower small-diameter roller 125. That is, the conveyance surface of sheet conveyed by conveyance belts 121A to 121D is level. Lower small-diameter rollers 125A to 125D rotate following the running of conveyance belt 121.

Air suction section 122 includes suction duct 122a that penetrates conveyance belts 121A to 121D, extends to the back side of the apparatus (suction conveyance section 12A side) and has suction ports on undersurfaces of portions corresponding to conveyance belts 121A to 121D, and a suction fan (not shown) disposed at the innermost part of suction duct 122a. When the suction fan operates, the pressure inside suction duct 122a becomes negative and a sheet is suctioned and adheres to conveyance belt 121 via the suction holes. The operation of the suction fan is controlled by control section 100.

Suction conveyance section 12 is provided with suction-status detection section 181 that detects whether or not a sheet adheres (is suctioned) to conveyance belt 121. Suction-status detection section 181 is constructed of, for example, detection flap 181a and transmission-type optical sensor (photointerrupter) 181b. Detection flap 181a is disposed between, for example, large-diameter roller 123B and large-diameter roller 123C. Optical sensor 181b includes a light-emitting section (not shown) and a light-receiving section (not shown), and detects the intensity of light incident on the light-receiving section.

When the sheet is not adhered to conveyance belt 121, one end of detection flap 181a protrudes downward below the conveyance surface of conveyance belt 121 and the other end stays at a position at which it does not block the light emitted from the light-emitting section of optical sensor 181b. On the other hand, when the sheet is adhered to conveyance belt 121, one end of detection flap 181a is pushed up to the conveyance surface of conveyance belt 121 and the other end stays at a position at which it blocks the light emitted from the light-emitting section of optical sensor 181b. It is possible to detect the position of detection flap 181a based on the intensity of light detected by optical sensor 181b and thereby determine whether or not the sheet is adhered to conveyance belt 121. However, suction-status detection section 181 cannot discriminate whether the sheet is adhered to conveyance belt 121 is a first sheet or a second sheet. Note that suction-status detection section 181 is not limited to this, and may adopt any configuration as long as the configuration makes it possible to detect whether or not a sheet is adhered to conveyance belt 121.

Floating-air blowing section 13 includes blowing fan 131 and air duct 132. Floating-air blowing section 13 is disposed inside each of side-end restriction members 114 and 115. FIG. 3 illustrates only floating-air blowing section 13 disposed inside side-end restriction member 115. Blowing fan 131 is configured to be capable of controlling the air volume according to the size of a sheet, paper quality, basis weight or the like and blowing air with an appropriate air volume. The operation of blowing fan 131 is controlled by control section 100.

Air duct 132 of floating-air blowing section 13 disposed inside side-end restriction member 115 communicates with air blowing port 115a. An air duct (not shown) of a floating-air blowing section (not shown) disposed inside side-end restriction member 114 communicates with air blowing port 114a. Since floating-air blowing section 13 is disposed inside side-end restriction members 114 and 115, even when the size of a sheet is changed, as side-end restriction members 114 and 115 move, floating-air blowing section 13 also moves together.

In floating-air blowing section 13, when blowing fan 131 operates, floating air is blown upward and the orientation of the floating air is changed by 90° by air duct 132. The floating air is then blown above the pile of sheets SS from both sides in the sheet width direction via air blowing ports 114a and 115a. This causes a few uppermost sheets of the pile of sheets SS to float.

Separating-air blowing section 14 includes blowing fan 141 and air duct 142. Separating-air blowing section 14 is disposed downstream of front-end restriction member 112 in the sheet conveyance direction. Blowing fan 141 is configured to be capable of controlling the air volume according to the size of a sheet, paper quality, basis weight and/or the like and blowing air with an optimum air volume. The operation of blowing fan 141 is controlled by control section 100.

Separating-air blowing section 14 may include a wind direction switching board (not shown) to make an air blowing direction switchable between the vicinity of the front end of suction conveyance section 12 and the vicinity of the front end of the pile of sheets SS. In this case, separating-air blowing section 14 blows floating air in the vicinity of the front end of the pile of sheets SS (first blowing) when floating-air blowing section 13 blows floating air and blows separating air in the vicinity of the front end of suction conveyance section 12 (second blowing) when floating-air blowing section 13 stops blowing floating air. That is, separating-air blowing section 14 functions as a floating-air blowing section as well.

In separating-air blowing section 14, when blowing fan 141 operates, air is blown in the vicinity of the front end of the pile of sheets SS or in the vicinity of the front end of suction conveyance section 12 via air blowing port 142a of air duct 142. Blowing floating air in the vicinity of the front end of the pile of sheets SS makes it possible to efficiently cause a few uppermost sheets of the pile of sheets SS to float. Furthermore, blowing separating air in the vicinity of the front end of suction conveyance section 12 makes it possible to separate the second uppermost and subsequent sheets from the plurality of sheets adhered to conveyance belt 121 and convey only the first sheet adhered to conveyance belt 121.

Exit roller section 15 includes upper conveyance roller 151 and lower conveyance roller 152 which is in contact with upper conveyance roller 151. Upper conveyance roller 151 is a drive roller and lower conveyance roller 152 is a driven roller. Exit roller section 15 sandwiches a sheet conveyed by suction conveyance section 12 between upper conveyance roller 151 and lower conveyance roller 152, and sends the sheet to the downstream side in the sheet conveyance direction.

Guide section 16 includes upper guide plate 161 and lower guide plate 162, and guides the sheet conveyed by suction conveyance section 12 to exit roller section 15. The sheet is conveyed through a gap formed between upper guide plate 161 and lower guide plate 162.

Sheet detection section 182 (so-called feed sensor) is disposed upstream of exit roller section 15 in the sheet conveyance direction. Sheet detection section 182 is configured of, for example, a reflection-type optical sensor and detects the presence or absence of a sheet based on intensity of the received reflected light. Sheet detection section 182 can detect that the sheet starts entering exit roller section 15. It is possible to calculate timing at which the sheet is ejected from exit roller section 15 based on the conveyance speed of the sheet and the sheet size at exit roller section 15. Sheet detection section 182 can detect sheet feeding defects such as paper jam. Note that a sheet detection section may also be disposed downstream of exit roller section 15 in the sheet conveyance direction to detect that the sheet is ejected from exit roller section 15.

In the present embodiment, sheet feeding apparatus 10 has an auto tray switch function. The auto tray switch function is a function that continues sheet feeding, when sheet feeding units 10A to 10C run out of sheets during continuous sheet feeding, by switching the sheet feeding unit to other sheet feeding units 10A to 10C where the same paper type, paper size, color or the like are set. The auto tray switch function automatically secures continuous operation of sheet feeding and can provide high productivity. The auto tray switch function is controlled by control section 100 based on a predetermined setting. With the setting, corresponding sheet feeding units 10A to 10C may be searched for based on the above-described paper type, paper size or the like and the switching destination may be determined according to the search result or the switching destination may be confirmed in advance and set and the auto tray switch function may be executed based on the setting.

However, with sheet feeding apparatus 10, there may be a case where a plurality of sheets are made to float by blowing by floating-air blowing section 13, a sheet located below the first sheet directly adhered to conveyance belt 121 (that is, the second and subsequent sheets) may float due to blowing of separating air directed to the plurality of sheets. In this case, as described in Background Art, in the related art using the sheet existence detection section such as the reflection-type sensor, actuator or transmission-type sensor, it may not be possible to accurately detect the presence or absence of a sheet in sheet storage section 11 immediately after the first sheet is conveyed adhered to conveyance belt 121. When it is not possible to accurately detect the presence or absence of a sheet in sheet storage section 11, the system may wait until the sheet floating due to blowing of separating air descends onto sheet placement tray 111, that is, floating of the sheet comes to an end, or the system may determine that there is no sheet when there is no change in the detection result of the sheet existence detection section after a wait for a certain time or detect that there is no sheet by combining a plurality of sheet existence detection sections. As a result, timing of detecting the presence or absence of a sheet in sheet storage section 11, and consequently timing of executing the auto tray switch function becomes late, causing a decrease in productivity.

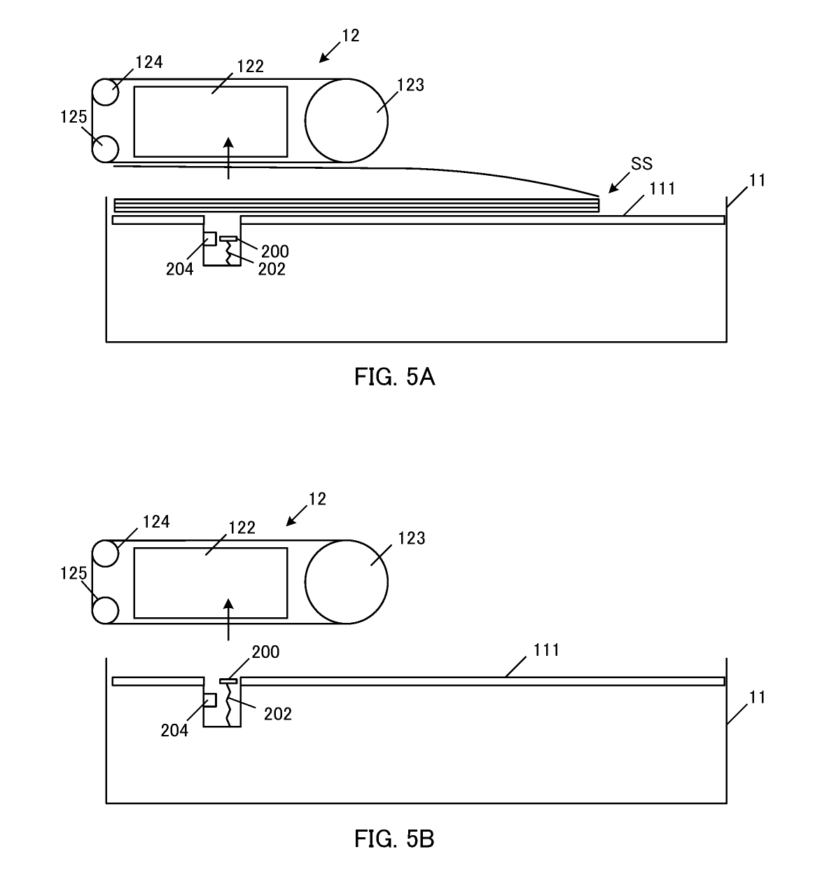

Thus, the present embodiment adopts a configuration in which the presence or absence of a sheet in sheet storage section 11 is not directly detected but indirectly detected using a suction flow by air suction section 122. The configuration will be described with reference to FIGS. 5A, 5B, and 5C. FIG. 5A is a diagram schematically illustrating sheet storage section 11 and suction conveyance section 12 when a pile of sheets SS are placed on sheet placement tray 111. FIG. 5B is a diagram schematically illustrating sheet storage section 11 and suction conveyance section 12 when no pile of sheets SS is placed on sheet placement tray 111.

As shown in FIG. 5A, floating member 200 (corresponding to the “displacement member” of the present invention) whose position is displaced in the suction direction (arrow direction in FIG. 5A) of air suction section 122 in accordance with the suction force received from air suction section 122 is provided at a position opposite to air suction section 122 with the pile of sheets SS placed in between when the pile of sheets SS are placed (that is, exist) on sheet placement tray 111, and at a position opposite to air suction section 122 when the pile of sheets SS are not placed (that is, do not exist) on sheet placement tray 111. Floating member 200 is connected to restriction member 202 (elastic member) that restricts displacement of the position of floating member 200. The elastic force of restriction member 202 will be described more specifically. When a suction force is generated from air suction section 122, the position of floating member 200 needs to be displaced in accordance with the suction force, and therefore the elastic force of restriction member 202 needs to be weaker than the suction force. On the other hand, when no suction force from air suction section 122 is generated, since floating member 200 needs to be returned to an original position (default position), the elastic force of restriction member 202 needs to be a level of elastic force that allows floating member 200 to return to the original position.

Displacement detection section 204 that detects displacement of the position of floating member 200 in the suction direction of air suction section 122 is provided in the vicinity of floating member 200 and restriction member 202. Displacement detection section 204 is composed of, for example, a reflection-type sensor provided with a light-receiving/emitting device and detects displacement of the position of floating member 200 depending on whether or not the light-receiving device receives reflected light of floating member 200 based on light from the light-emitting device. Floating member 200, restriction member 202 and displacement detection section 204 are configured as parts of sheet placement tray 111.

When the pile of sheets SS exist on sheet placement tray 111 as shown in FIG. 5A, the suction force of air suction section 122 is blocked by the pile of sheets SS and floating member 200 does not float (move) in the suction direction of air suction section 122. In this case, the light emitted from the light-emitting device of displacement detection section 204 is reflected by floating member 200 and received by the light-receiving device of displacement detection section 204. Displacement detection section 204 then outputs detection information indicating that the position of floating member 200 has not been displaced to control section 100. Note that when the pile of sheets SS is placed on sheet placement tray 111, floating member 200 is preferably restricted by restriction member 202 so as not to protrude from the placement surface of sheet placement tray 111. This is because when floating member 200 protrudes from the placement surface of sheet placement tray 111, floating member 200 may be caught in the pile of sheets SS placed on sheet placement tray 111.

On the other hand, when no pile of sheets SS exists on sheet placement tray 111 as shown in FIG. 5B, the suction force of air suction section 122 is not blocked by the pile of sheets SS (that is, floating member 200 receives the suction force), floating member 200 floats in the suction direction by air suction section 122. In this case, the light emitted from the light-emitting device of displacement detection section 204 is not reflected by floating member 200, and is therefore not received by the light-receiving device of displacement detection section 204. Displacement detection section 204 then outputs detection information indicating that the position of floating member 200 has been displaced to control section 100. As described with reference to FIGS. 5A and 5B, control section 100 can accurately detect the presence or absence of a sheet in sheet storage section 11 based on the detection information outputted from displacement detection section 204. Thus, even in the middle of blowing of separating air, that is, when sheets (that is, the second and subsequent sheets) located below the first sheet directly adhered to conveyance belt 121 may be floating due to the separating air, it is possible to accurately detect the presence or absence of a sheet in sheet storage section 11 using a single detection section. Consequently, it is possible to prevent a delay in execution timing of the auto tray switch function, which otherwise results in a decrease in productivity.

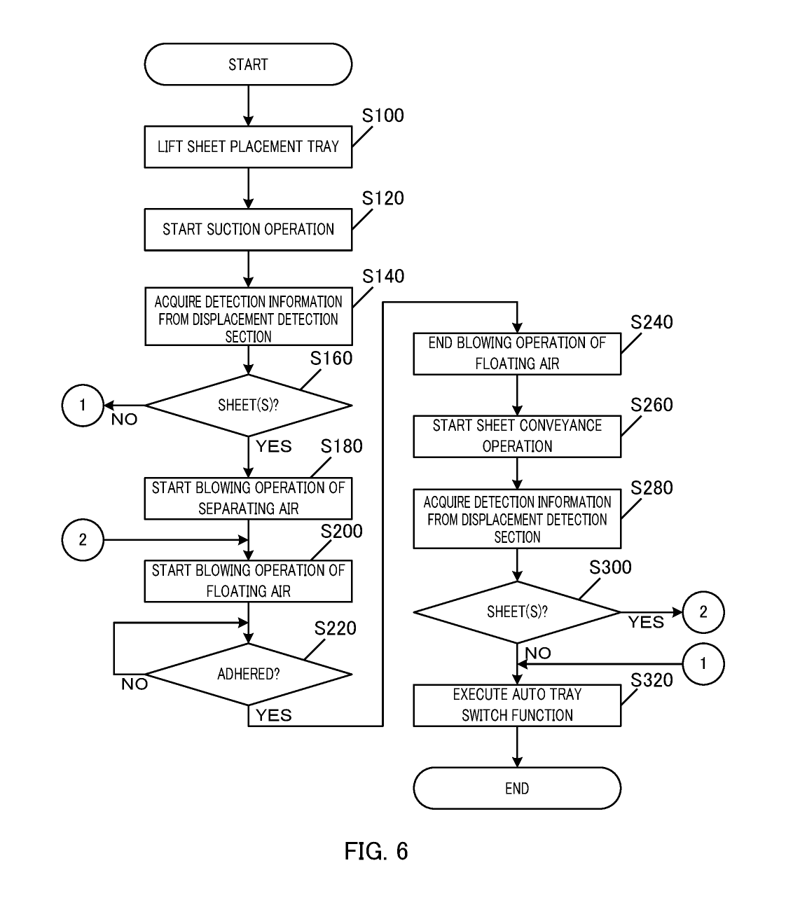

FIG. 6 is a flowchart illustrating an example of sheet feeding processing by sheet feeding apparatus 10. The sheet feeding processing shown in FIG. 6 is performed, for example, by CPU 101 executing a predetermined program stored in ROM 102 when sheet feeding start information is inputted from image forming apparatus 20. Note that sheet placement tray 111 has descended to the lowest position in preparation for a supply of sheets.

First, control section 100 causes sheet placement tray 111 to ascend up to a predetermined position (step S100). Here, the predetermined position refers to, when no sheet is placed on sheet placement tray 111, a position where the position of floating member 200 can be displaced by a suction force received from air suction section 122. This is because if the distance between air suction section 122 and floating member 200 is too large, floating member 200 cannot receive the suction force from air suction section 122 and is not therefore displaced.

Next, control section 100 controls air suction section 122 so as to start suctioning by air (step S120). Air suction section 122 continues suctioning by air all the time until an end of the sheet feeding processing.

Next, control section 100 acquires detection information from displacement detection section 204 (step S140). That is, when sheet placement tray 111 ascends up to the predetermined position and an air suction operation by air suction section 122 starts, control section 100 acquires the detection information indicating the detection result of displacement detection section 204 and thereby determines the presence or absence of a sheet in sheet storage section 11. Next, control section 100 determines whether or not there is a sheet in sheet storage section 11 (more specifically, on sheet placement tray 111) based on the acquired detection information (step S160). When the determination result shows that there is no sheet in sheet storage section 11 (step S160, NO), the process moves to step S320.

On the other hand, when there is a sheet in sheet storage section 11 (step S160, YES), control section 100 controls separating-air blowing section 14 so as to start a separating-air blowing operation in the vicinity of the front end of suction conveyance section 12 (step S180). Next, control section 100 controls floating-air blowing section 13 so as to start a floating-air blowing operation on an upper lateral part of the pile of sheets SS (step S200). A few uppermost sheets of the pile of sheets SS stored in sheet storage section 11 float against its own weight. The floating sheets are suctioned by air suction section 122 and adhered to conveyance belt 121.

Next, control section 100 determines whether or not the sheet is adhered to conveyance belt 121 based on the detection result of suction-status detection section 181. When the determination result shows that the sheet is not adhered to conveyance belt 121 (step S220, NO), the process returns to the step preceding step S220.

On the other hand, when the sheet is adhered to conveyance belt 121 (step S220, YES), control section 100 controls floating-air blowing section 13 so as to end the floating-air blowing operation on the upper lateral part of the pile of sheets SS (step S240). Next, control section 100 causes the sheet conveyance operation to start. More specifically, control section 100 controls suction conveyance section 12 so as to cause conveyance belt 121 to run (step S260). Furthermore, control section 100 controls exit roller section 15 so as to cause upper conveyance roller 151 to rotate (step S260). Conveyance belt 121 runs and the first sheet is thereby conveyed while being adhered to conveyance belt 121.

Next, control section 100 acquires detection information from displacement detection section 204 (step S280). Next, control section 100 determines whether or not there is a sheet in sheet storage section 11 based on the acquired detection information (step S300). When the determination result shows that there is a sheet in sheet storage section 11 (step S300, YES), the process returns to the step preceding step S200.

On the other hand, when there is no sheet in sheet storage section 11 (step S300, NO), control section 100 causes the auto tray switch function to be executed (step S320). The process in step S320 is completed and the sheet feeding processing by sheet feeding apparatus 10 thereby ends.

As described in detail above, sheet feeding apparatus 10 according to the present embodiment includes: sheet storage section 11 that includes sheet placement tray 111 that allows a plurality of sheets to be placed thereon and stores the sheets; conveyance belt 121 that is located above the sheets placed on sheet placement tray 111 and conveys the sheets in the sheet conveyance direction while the sheets are adhered to conveyance belt 121; air suction section 122 that is provided at an inner side of conveyance belt 121, suctions air to cause the sheets placed on sheet placement tray 111 to be adhered to conveyance belt 121; floating member 200 that is provided at a position opposite to air suction section 122 with the sheet placed in between when there is a sheet in sheet placement tray 111 or at a position opposite to air suction section 122 when there is no sheet on sheet placement tray 111, the position of floating member 200 being displaced in accordance with a suction force received from air suction section 122; displacement detection section 204 that detects a displacement of the position of floating member 200; and control section 100 that detects the presence or absence of a sheet in sheet storage section 11 based on the detection result of displacement detection section 204.

Thus, according to the present embodiment configured as described above, even in the middle of blowing of separating air, that is, when sheets located below the first sheet directly adhered to conveyance belt 121 due to the separating air may be floating, control section 100 can accurately detect the presence or absence of a sheet in sheet storage section 11 using a single detection section. Consequently, it is possible to prevent a delay in execution timing of the auto tray switch function, which otherwise results in a decrease in productivity.

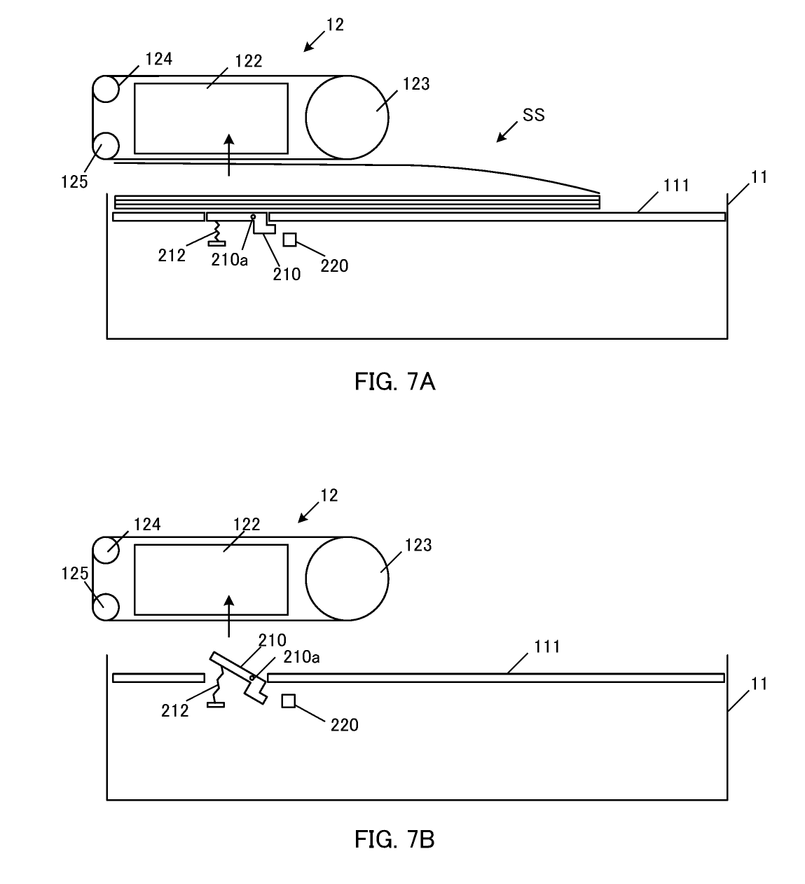

Note that in the above-described embodiment, floating member 200 may be configured to be rotatable in a predetermined rotating direction and the rotation position in the above-described rotating direction may be displaced in accordance with the suction force received from air suction section 122. The configuration in this case will be described with reference to FIG. 7. FIG. 7A is a diagram schematically illustrating sheet storage section 11 and suction conveyance section 12 when the pile of sheets SS are placed on sheet placement tray 111. FIG. 7B is a diagram schematically illustrating sheet storage section 11 and suction conveyance section 12 when the pile of sheets SS are not placed on sheet placement tray 111.

When the pile of sheets SS is placed on sheet placement tray 111 as shown in FIG. 7A, floating member 210 is provided at a position opposite to air suction section 122 with the pile of sheets SS placed in between and configured to be rotatable around rotation center 210a in a predetermined rotating direction (clockwise direction in FIG. 7), the rotation position in the rotating direction thereof being displaced in accordance with a suction force received from air suction section 122. Floating member 210 is connected to restriction member 212 (elastic member) that restricts displacement of the rotation position of floating member 210.

Displacement detection section 220 that detects displacement of the rotation position of floating member 210 in accordance with the suction force from air suction section 122 is provided in the vicinity of floating member 210 and restriction member 212. Displacement detection section 220 is composed of, for example, a reflection-type sensor provided with a light-receiving/emitting device and detects displacement of the position of floating member 210 depending on whether or not reflected light of floating member 210 based on the light from light-emitting device is received by the light-receiving device. Floating member 210, restriction member 212 and displacement detection section 220 are configured as parts of sheet placement tray 111.

When the pile of sheets SS exists on sheet placement tray 111 as shown in FIG. 7A, the suction force of air suction section 122 is blocked by the pile of sheets SS and floating member 210 does not rotate in a predetermined rotating direction. In this case, since light emitted from the light-emitting device of displacement detection section 220 is not reflected by floating member 210, the light is not received by the light-receiving device of displacement detection section 220. Displacement detection section 220 then outputs detection information indicating that the position of floating member 210 is not displaced to control section 100.

On the other hand, when no pile of sheets SS exists on sheet placement tray 111 as shown in FIG. 7B, the suction force of air suction section 122 is not blocked (that is, floating member 210 receives the suction force) by the pile of sheets SS, and floating member 210 rotates in the predetermined rotating direction. In this case, the light emitted from the light-emitting device of displacement detection section 220 is reflected by floating member 210 and received by the light-receiving device of displacement detection section 220. Displacement detection section 220 outputs detection information indicating that the position of floating member 210 has been displaced to control section 100. As has been described with reference to FIGS. 7A and 7B, control section 100 can accurately detect the presence or absence of a sheet in sheet storage section 11 based on the detection information outputted from displacement detection section 220. Thus, even in the middle of blowing of separating air, that is, when sheets located below the first sheet directly adhered to conveyance belt 121 due to the separating air may be floating, it is possible to accurately detect the presence or absence of a sheet in sheet storage section 11 using one detection section.

Floating member 200 in the above-described embodiment is preferably provided on the rear-end side in the sheet conveyance direction of the sheet placed on sheet placement tray 111 as much as possible. In contrast to the case where floating member 200 is provided on the front-end side in the sheet conveyance direction, floating member 200 in this configuration can receive the suction force from air suction section 122 earlier when no pile of sheets SS exist in sheet placement tray 111. Consequently, displacement detection section 204 can detect displacement of the position of floating member 200 earlier, and control section 100 can thereby accurately and early detect the presence or absence of a sheet in sheet storage section 11.

According to the above-described embodiment, the region where the sheet receives the suction force from air suction section 122 (hereinafter simply referred to as “region that receives a suction force”) in the sheet conveyance direction of the sheet placed in sheet placement tray 111 depends on the size of the surface of air suction section 122 opposite to the sheet or the size of the surface of suction conveyance section 12 opposite to the sheet. Floating member 200 provided at a position corresponding to the region that receives the suction force is more susceptible to the suction force. Thus, floating member 200 is preferably provided at a position corresponding to the region that receives the suction force more.

Air suction section 122 according to the above-described embodiment may perform a suction operation so that a suction force at a first position opposite to floating member 200 in the sheet conveyance direction becomes stronger than a suction force at a second position other than the first position. This is intended to enable, when no sheet is placed on sheet placement tray 111, the position of floating member 200 to be reliably displaced by the suction force received from air suction section 122.

In the above-described embodiment, the number of conveyance belts 121 provided for sheet feeding apparatus 10 is not limited to four, and sheet feeding apparatus 10 may be provided with at least one conveyance belt 121.

In the above-described embodiment, when control section 100 executes the auto tray switch function, a notification section may be provided which notifies operation display section 22 of image forming apparatus 20 of the tray (sheet storage section) running out of sheets and the information indicating that there is no more sheet using a predetermined notification form (e.g., popup).

In the above-described embodiment, the mode in which floating member 200 and sheet placement tray 111 are integrated as one unit has been described, but the present invention is not limited to this. In short, floating member 200 needs only to be provided at a position opposite to air suction section 122 with the sheet placed in between when a sheet exists on sheet placement tray 111 or at a position opposite to air suction section 122 when there is no sheet on sheet placement tray 111, and floating member 200 and sheet placement tray 111 may be integrated as one unit or may be separate bodies.

In the above-described embodiment, the configuration of sheet feeding apparatus 10 may be applied to sheet feeding section 26 of image forming apparatus 20.

An example has been described in the above-described embodiment where sheet feeding apparatus 10 is provided with control section 100, but sheet feeding apparatus 10 need not always be provided with control section 100. In this case, the control section provided for the apparatus connected to sheet feeding apparatus 10 (e.g., control section 28 of image forming apparatus 20) may control each component provided for sheet feeding apparatus 10.

In addition, all the above-described embodiments merely illustrate examples of embodiment in implementing the present invention, and the technical scope of the present invention should not thus be interpreted in a restrictive manner. That is, the present invention can be implemented in various modes without departing from the spirit and scope of the present invention or main features thereof.

What is claimed is:

1. A sheet feeding apparatus comprising:
a sheet storage section including a sheet placement tray where a plurality of sheets are to be placed, the sheet storage section being configured to store the sheets;
a conveyance belt located above the sheets placed on the sheet placement tray, the conveyance belt being configured to convey the sheets adhering in a sheet conveyance direction;
a suction section provided at an inner side of the conveyance belt and configured to suction air to cause the sheets placed on the sheet placement tray to adhere to the conveyance belt;
a displacement member provided at a position opposite to the suction section with the sheets placed in between when the sheets exist on the sheet placement tray or at a position opposite to the suction section when no sheet exists on the sheet placement tray, the displacement member being displaced in position in accordance with a suction force received from the suction section;
a displacement detection section configured to detect displacement of the position of the displacement member; and
a control section configured to detect the presence or absence of a sheet in the sheet storage section based on the detection result of the displacement detection section.

2. The sheet feeding apparatus according to claim 1, wherein the position of the displacement member is displaced in a suction direction by the suction section in accordance with the suction force received from the suction section.

3. The sheet feeding apparatus according to claim 2, further comprising a restriction member configured to restrict displacement of the position of the displacement member.

4. The sheet feeding apparatus according to claim 1, wherein the displacement member is configured to be rotatable in a predetermined rotating direction and a rotation position in the rotating direction is displaced in accordance with the suction force received from the suction section.

5. The sheet feeding apparatus according to claim 1, wherein the displacement member is provided on a rear-end side in the sheet conveyance direction of the sheets placed on the sheet placement tray.

6. The sheet feeding apparatus according to claim 1, wherein the suction section performs a suction operation so that a suction force at a first position opposite to the displacement member is stronger than a suction force at a second position other than the first position in the sheet conveyance direction.

7. The sheet feeding apparatus according to claim 1, wherein:
the displacement member is provided at the sheet placement tray, and
when no sheet exists on the sheet placement tray, a position of the sheet placement tray is controlled so that the position of the displacement member is displaced by the suction force received from the suction section.

8. An image forming apparatus comprising:
a sheet storage section including a sheet placement tray where a plurality of sheets are to be placed, the sheet storage section being configured to store the sheets;
a conveyance belt located above the sheets placed on the sheet placement tray, the conveyance belt being configured to convey the sheets adhering in a sheet conveyance direction;
a suction section provided at an inner side of the conveyance belt and configured to suction air to cause the sheets placed on the sheet placement tray to adhere to the conveyance belt;
a displacement member provided at a position opposite to the suction section with the sheets placed in between when the sheets exist on the sheet placement tray or at a position opposite to the suction section when no sheet exists on the sheet placement tray, the displacement member being displaced in position in accordance with a suction force received from the suction section;
a displacement detection section configured to detect displacement of the position of the displacement member; and
a control section configured to detect the presence or absence of a sheet in the sheet storage section based on the detection result of the displacement detection section.

9. An image formation system comprising:
the sheet feeding apparatus according to claim 1; and
an image forming apparatus connected to the sheet feeding apparatus and configured to form an image on a sheet fed from the sheet feeding apparatus.
